(19) United States
(12) Patent Application Publication
(10) Pub. No.: US 2023/0210244 A1
(43) Pub. Date: Jul. 6, 2023

(54) HAIR TREATMENT DEVICE

(71) Applicant: Dewei Luo, Shenzhen (CN)

(72) Inventor: Dewei Luo, Shenzhen (CN)

(21) Appl. No.: 18/181,580

(22) Filed: Mar. 10, 2023

Related U.S. Application Data
(63) Continuation of application No. PCT/CN2021/075000, filed on Feb. 3, 2021.

(30) Foreign Application Priority Data
Sep. 11, 2020 (CN) 202021991551.6

(51) Int. Cl. A45D 44/00

(52) U.S. Cl. CPC A45D 44/00; A45D 2200/00

(57) ABSTRACT

A hair treatment device includes a main body and a housing. The main body includes a tool bit device. The housing includes an accommodating cavity. The tool bit device is movably accommodated in the accommodating cavity in a telescopic manner. When the tool bit device is accommodated in the accommodating cavity, the tool bit device is automatically turned off; and when the tool bit device extends out of the accommodating cavity, the tool bit device is automatically turned on. According to the hair treatment device of the present disclosure, the tool bit device is movably accommodated in the accommodating cavity in the telescopic manner, so that the tool bit device is effectively protected. Meanwhile, the tool bit device is disposed to be automatically turned on or turned off, which is not required to manually operate a control switch to control an on-and-off state of the tool bit device.

### CROSS REFERENCE

The present application is a continuation-application of International (PCT) Patent Application No. PCT/CN2021/075000 filed on Feb. 3, 2021, which claims foreign priorities of Chinese Patent Application No. 202021991551.6, filed on Sept. 11, 2020, the entire contents of which are hereby incorporated by reference.

### TECHNICAL FIELD

The present disclosure relates to a field of beauty devices, and in particular to a hair treatment device.

### BACKGROUND

At present, as women play a more and more important role in society, women are employed in almost every industry. Beauty and makeup have become an indispensable part in life of most of the women, and hair treatment devices for removing hair of human bodies are a necessity for daily life of people. Aiming at hair on different parts of the human bodies, the hair treatment devices mainly include a hair shaving device for shaving hair on a human head, a hair removal device for removing hair on legs and fine hair on the human bodies, and an eyebrow trimming device for trimming eyebrow. However, current hair treatment devices for trimming the eyebrow are generally provided with a cover main body to protect a tool bit component, which is complex in structure, is required to manually operate a control switch, and is tedious in a process of operating, thereby causing a problem that the hair treatment device is not convenient enough for a user to use.

### SUMMARY

In order to solve above problems, the present disclosure provides a hair treatment device, which effectively protects a tool bit device, is not required to manually operate a control switch to control an on-and-off state of the tool bit device, and is simple and convenient to operate.

The present disclosure is implemented by following technical solutions.

The present disclosure provides the hair treatment device, including a main body and a housing. The main body includes a tool bit device. The housing includes an accommodating cavity. The tool bit device is movably accommodated in the accommodating cavity in a telescopic manner. When the tool bit device is accommodated in the accommodating cavity, the tool bit device is automatically turned off; and when the tool bit device extends out of the accommodating cavity, the tool bit device is automatically turned on.

Furthermore, the main body includes a Hall switch. A magnet is disposed in the accommodating cavity. When the tool bit device is accommodated in the accommodating cavity, the Hall switch is close to the magnet; and when the tool bit device extends out of the accommodating cavity, the Hall switch is distal from the magnet.

Furthermore, an accommodating groove is defined on a bottom wall of the accommodating cavity. The magnet is fixedly disposed in the accommodating groove.

Furthermore, the main body is connected to the bottom wall of the accommodating cavity through an elastic element. When the tool bit device is accommodated in the accommodating cavity, the elastic element is compressed; and when the tool bit device extends out of the accommodating cavity, the elastic element is stretched.

Furthermore, a locking device is further fixedly disposed in the accommodating cavity. The main body includes a self-locking push rod. The self-locking push rod is movably locked on the locking device.

Furthermore, sliding sleeves are further fixedly disposed in the accommodating cavity. The main body includes balls. When the tool bit device is stretched out and drew back in the accommodating cavity, the balls slide on the sliding sleeves.

Furthermore, the sliding sleeves include two sliding sleeves. The two sliding sleeves are symmetrically disposed in the accommodating cavity. A sliding groove for the balls to slide is disposed on each of the two sliding sleeves.

Furthermore, the balls are disposed in two rows. The two rows of the balls are symmetrically disposed in the main body.

Furthermore, the accommodating cavity includes an opening. The main body includes a switch plate. The switch plate is movably disposed in the opening. When the tool bit device is accommodated in the accommodating cavity, the switch plate does not protrude with respect to a starting surface of the opening.

Furthermore, a row of positioning holes are further defined on the housing. When the tool bit device is accommodated in the accommodating cavity, the tool bit device corresponds to the row of the positioning holes.

Beneficial effects of the present disclosure are as follows.

The present disclosure provides the hair treatment device, including the main body having the tool bit device and the housing having the accommodating cavity. The tool bit device is movably accommodated in the accommodating cavity in the telescopic manner. When the tool bit device is accommodated in the accommodating cavity, the tool bit device is automatically turned off; and when the tool bit device extends out of the accommodating cavity, the tool bit device is automatically turned on. According to the hair treatment device of the present disclosure, the tool bit device is movably accommodated in the accommodating cavity in the telescopic manner, so that the tool bit device is effectively protected. Meanwhile, the tool bit device is disposed to be automatically turned on or turned off, which does not need to manually operate the control switch to control the on-and-off state of the tool bit device, and is simple and convenient to operate.

### BRIEF DESCRIPTION OF DRAWINGS

FIG. 1 is a cross-sectional structural schematic diagram of a hair treatment device according to one embodiment of the present disclosure.

FIG. 2 is an exploded structural schematic diagram of the hair treatment device according to one embodiment of the present disclosure.

FIG. 3 is a partial structural schematic diagram of the hair treatment device according to one embodiment of the present disclosure.

### DETAILED DESCRIPTION

In order to describe technical solutions of the present disclosure more clearly and completely, the present disclosure is further described below with reference to accompanying drawings.

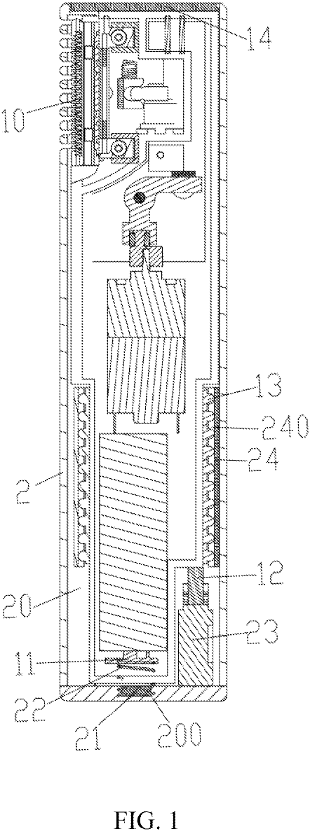

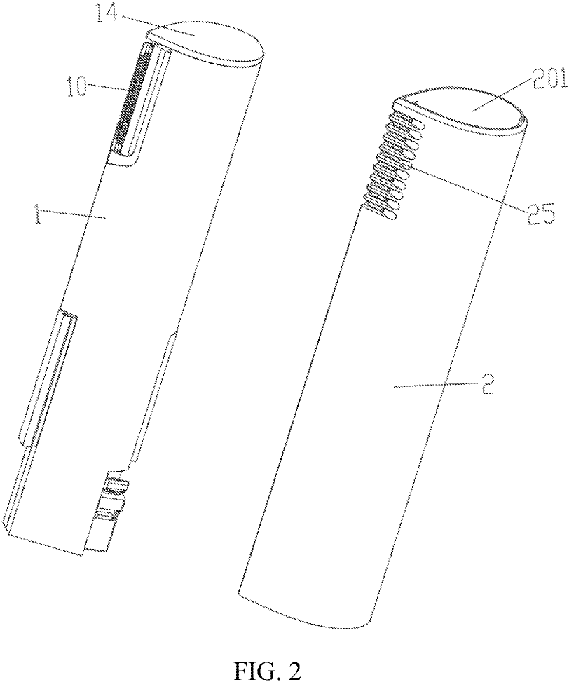

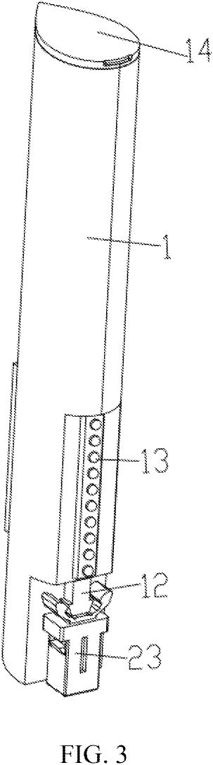

As shown in FIGS. 1-3, the present disclosure provides a hair treatment device including: a main body 1 and a housing. The main body 1 includes a tool bit device 10. The housing includes an accommodating cavity 20. The tool bit device 10 is movably accommodated in the accommodating cavity 20 in a telescopic manner. When the tool bit device 10 is accommodated in the accommodating cavity 20, the tool bit device 10 is automatically turned off; and when the tool bit device 10 extends out of the accommodating cavity 20, the tool bit device 10 is automatically turned on.

In the embodiment, according to the hair treatment device of the present disclosure, the tool bit device 10 is movably accommodated in the accommodating cavity 20 in the telescopic manner, so that the tool bit device 10 is effectively protected without setting a cover main body to cover, which is more convenient in operation. Meanwhile, the tool bit device 10 is disposed to be automatically turned on or turned off, which does not need to manually operate the control switch to control an on-and-off state of the tool bit device, and is simple and convenient to operate.

Furthermore, the main body 1 includes a Hall switch 11. A magnet 21 is disposed in the accommodating cavity 20. When the tool bit device 10 is accommodated in the accommodating cavity 20, the Hall switch 11 is close to the magnet 21; and when the tool bit device 10 extends out of the accommodating cavity 20, the Hall switch 11 is distal from the magnet 21.

In the embodiment, a control circuit board is disposed in the main body 1. The Hall switch 11 is disposed on the control circuit board and is electrically connected to the control circuit board, and the control circuit board is electrically connected to a driving motor for driving the tool bit device 10 to work at the same time. When the tool bit device 10 is accommodated in the accommodating cavity 20, the Hall switch 11 is close to the magnet 21. At the moment, the control circuit board controls the driving motor to be turned off, and the tool bit device 10 is automatically turned off and stops working. When the tool bit device 10 extends out of the accommodating cavity 20, the Hall switch 11 is distal from the magnet 21, at the moment, the control circuit board controls the driving motor to be turned on, and the tool bit device 10 is automatically turned on to work. The Hall switch 11 senses a magnetic force of the magnet 21, so that the control circuit board controls the driving motor to be turned on or turned off.

Furthermore, an accommodating groove 200 is defined on a bottom wall of the accommodating cavity 20. The magnet 21 is fixedly disposed in the accommodating groove 200.

Furthermore, the main body 1 is connected to the bottom wall of the accommodating cavity 20 through an elastic element 22. When the tool bit device 10 is accommodated in the accommodating cavity 20, the elastic element 22 is compressed; and when the tool bit device 10 extends out of the accommodating cavity 20, the elastic element 22 is stretched. The elastic element 22 is a spring having an elastic force.

Furthermore, a locking device 23 is further fixedly disposed in the accommodating cavity 20. The main body 1 includes a self-locking push rod 12. The self-locking push rod 12 is movably locked on the locking device 23.

In the embodiment, the locking device 23 is made of a silica gel material and has certain elasticity.

Furthermore, sliding sleeves 24 are further fixedly disposed in the accommodating cavity 20. The main body 1 includes balls 13. When the tool bit device 10 is stretched out and drew back in the accommodating cavity 20, the balls 13 slide on the sliding sleeves 24.

Furthermore, the sliding sleeves 24 include two sliding sleeves 24. The two sliding sleeves 24 are symmetrically disposed in the accommodating cavity 20. A sliding groove 240 for the balls 13 to slide is disposed on each of the two sliding sleeves 24.

In the embodiment, the balls 13 are disposed to slide on the sliding sleeves 24, so that the tool bit device 10 slides more smoothly when the tool bit device 10 is stretched out and drew back.

Furthermore, the balls 13 are disposed in two rows. The two rows of the balls 13 are symmetrically disposed in the main body 1.

Furthermore, the accommodating cavity 20 includes an opening 201. The main body 1 includes a switch plate 14. The switch plate 14 is movably disposed in the opening 201. When the tool bit device 10 is accommodated in the accommodating cavity 20, the switch plate 14 does not protrude with respect to a starting surface of the opening 201.

During use, the tool bit device 10 is accommodated in the accommodating cavity 20, the switch plate 14 is just flush with the starting surface of the opening 201. At the moment, the elastic element 22 is compressed. When a user needs to turn on the tool bit device 10, the user presses the switch plate 14, the switch plate 14 sinks with respect to the starting surface of the opening 201, the self-locking push rod 12 ejects the locking device 23, and meanwhile, the elastic element 22 is further compressed. When the user revokes pressing force on the switch plate 14, the elastic element 22 is stretched, the elastic element 22 returns a force to enable the self-locking push rod 12 to be separated from the locking device 23, the tool bit device 10 extends out of the accommodating cavity 20, and meanwhile, the tool bit device 10 starts to be turned on. When the user needs to turn off the tool bit device 10, the user pushes the switch plate 14 until the switch plate 14 is flush with the starting surface of the opening 201, the tool bit device 10 is accommodated in the accommodating cavity 20 again, and meanwhile, the tool bit device 10 starts to be turned off. The self-locking push rod 12 is locked to the locking device 23 again to enable the tool bit device 10 to be kept in the accommodating cavity 20, and at the moment, the elastic element 22 is compressed.

Furthermore, a row of positioning holes 25 are further defined on the housing. When the tool bit device 10 is accommodated in the accommodating cavity 20, the tool bit device 10 corresponds to the row of the positioning holes 25.

Certainly, the present disclosure may further have other various embodiments, and based on the embodiment, a person of ordinary skill in the art may obtain other embodiments without making any creative effort, all of which fall within scopes of protection of the present disclosure.

What is claimed is:

1. A hair treatment device, comprising:
a main body; and
a housing;
wherein the main body comprises a tool bit device, the housing comprises an accommodating cavity, and the tool bit device is movably accommodated in the accommodating cavity in a telescopic manner; when the tool bit device is accommodated in the accommodating cavity, the tool bit device is automatically turned off; and when the tool bit device extends out of the accommodating cavity, the tool bit device is automatically turned on.

2. The hair treatment device according to claim 1, wherein the main body comprises a Hall switch, a magnet is disposed in the accommodating cavity; when the tool bit device is accommodated in the accommodating cavity, the Hall switch is close to the magnet; and when the tool bit device extends out of the accommodating cavity, the Hall switch is distal from the magnet.

3. The hair treatment device according to claim 2, wherein an accommodating groove is defined on a bottom wall of the accommodating cavity, and the magnet is fixedly disposed in the accommodating groove.

4. The hair treatment device according to claim 1, wherein the main body is connected to the bottom wall of the accommodating cavity through an elastic element; when the tool bit device is accommodated in the accommodating cavity, the elastic element is compressed; and when the tool bit device extends out of the accommodating cavity, the elastic element is stretched.

5. The hair treatment device according to claim 1, wherein a locking device is further fixedly disposed in the accommodating cavity, the main body comprises a self-locking push rod, and the self-locking push rod is movably locked on the locking device.

6. The hair treatment device according to claim 1, wherein sliding sleeves are further fixedly disposed in the accommodating cavity, the main body comprises balls, and when the tool bit device is stretched out and drew back in the accommodating cavity, the balls slide on the sliding sleeves.

7. The hair treatment device according to claim 6, wherein the sliding sleeves comprise two, the two sliding sleeves are symmetrically disposed in the accommodating cavity, and a sliding groove for the balls to slide is disposed on each of the two sliding sleeves.

8. The hair treatment device according to claim 6, wherein the balls are disposed in two rows, and the two rows of the balls are symmetrically disposed in the main body.

9. The hair treatment device according to claim 1, wherein the accommodating cavity comprises an opening, the main body comprises a switch plate, the switch plate is movably disposed in the opening; when the tool bit device is accommodated in the accommodating cavity, the switch plate does not protrude with respect to a starting surface of the opening.

10. The hair treatment device according to claim 1, wherein a row of positioning holes are further defined on the housing, and when the tool bit device is accommodated in the accommodating cavity, the tool bit device corresponds to the row of the positioning holes.
